(19) United States
(12) Patent Application Publication
(10) Pub. No.: US 2009/0320290 A1
(43) Pub. Date: Dec. 31, 2009

(54) Fluid ports used in bladder type hydraulic accumulators

(76) Inventor: Donna Martina Bennett, (US)

Correspondence Address: Donna M. Bennett, 7826 Marinette Dr., Houston, TX, 77074, US

(21) Appl. No.: 11/690,117

(22) Filed: Jun. 27, 2008

(51) Int. Cl. B23P 15/00

(52) U.S. Cl. 29/890.06

(57) ABSTRACT

The improvement in the manufacturing of fluid ports commonly used hydraulic bladder type accumulators by the manufacturing of the fluid port body and the poppet valve guide as separate pieces in the manufacturing process.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

The current invention is in regard to the fluid port body used with bladder type hydraulic accumulators. The normal fluid port body is made as a one piece machined part containing and aligning the poppet valve used to close the fluid port when the supply of pressurized fluid is exhausted from the hydraulic accumulator to prevent the bladder (containing pressurized gas) from being extruded through the fluid port and damaged. The poppet valve is centrally aligned by a central guide hole passing along the longitudinal axis of the valve body. An array of holes surround the poppet guide hole and perforate the disk of material that supports the poppet guide. Traditionally the machining of the body has been done from both ends working toward the poppet guide support.

The traditional process and design have several limitations. First, the fluid port discharge side (on the end away from the body of the accumulator) must be of sufficient size to accommodate machine tool bits, which limits the minimum size useable. Second, the discharge side opening must be large enough to allow connection of the retaining device (normally a nut screwed onto the end of the poppet stem) to be inserted and connected. Third, as the discharge side opening becomes smaller (as is common in higher pressure hydraulic accumulators), it becomes necessary to either do very difficult and expensive undercut machining on the inside of the fluid port or to introduce an adapter to allow for the reduction in size of the fluid outlet (thus introducing a leak point into the assembly).

### BRIEF SUMMARY OF THE INVENTION

The current invention is the production of the fluid port body with the poppet stem guide made as a separate piece from the remainder of the fluid port body. The poppet stem guide is screwed into or otherwise suitably retained in the fluid port body, as by retaining rings or other appropriate methods.

The advantages of the two-piece fluid port design are as follows: First, the separate machining of both the poppet guide and the fluid port body are significantly easier than is possible when the complete fluid port is made as one piece. Second, the opening for the fluid discharge can be made as small as is needed without introducing unwanted potential leak points into the assembly. Third, the parts attached to the poppet stem guide can be assembled outside the fluid port body thereby negating the necessity to insert a poppet retaining device through the fluid port. Fourth, the materials used for the outer shell of the fluid port and the poppet stem guide do not need to be made of the same material, allowing each part to have optimal material properties.

### BRIEF DESCRIPTION OF THE SEVERAL VIEWS OF THE DRAWING

FIG. 1 shows the front and section views of the improved fluid port design as separately machined pieces.

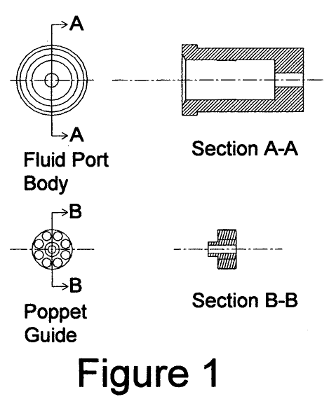

FIG. 2 shows the section views of the improved fluid port design assembled into one assembly along with the poppet, spring, nut, and washer normally associated with an accumulator fluid port assembly.

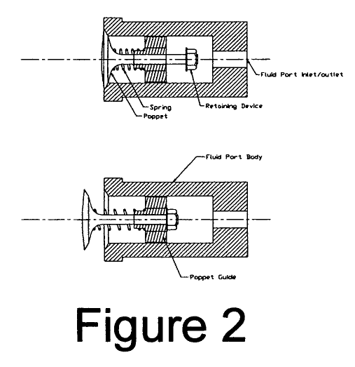

### DETAILED DESCRIPTION OF THE INVENTION

The manufacturing of the fluid port will be done in two parts: one will be made out of a length of tubing for the outer shell and one will be made from a piece of flat stock for the poppet guide. The length of tubing is machined in a conventional manner except that there is no need to reverse the piece while machining or making severe undercuts in the part. The poppet guide will be readily accessible throughout the manufacturing process without the need to do complex machining in a difficult to reach or measure location. After machining to the final configuration, the parts can readily be treated in any manner appropriate to optimizing the various properties, such as ductility, hardness, wear resistance etc. without changing the properties of the other part of the fluid port. After any post machining treatments the poppet, the poppet spring, any spacers or other items used on the poppet valve stem and the retaining device will be mounted onto the poppet stem guide as a sub-assembly. This improves consistency in the assembly and allows for better quality control of the assembled parts. The assembled poppet valve sub-assembly is then inserted into the machined outer shell and retained in place by either screwing it securely into the outer shell or by any of a number of other methods to insure that the poppet valve sub-assembly is securely located and fixed with the outer shell. Since the only forces working on the poppet guide are those that are supplied by the spring that normally opens the poppet and any type of damper that may be present to prevent the poppet valve from opening too swiftly, the material used in the poppet guide does not need to have the same high strength properties required of the fluid port shell.

1. The improvements in the manufacture of fluid ports commonly used in hydraulic bladder type accumulators with the poppet guide made as a separate piece from the fluid port body.
